(19) United States
(12) Patent Application Publication
(10) Pub. No.: US 2016/0362155 A1
(43) Pub. Date: Dec. 15, 2016

(54) ADJUSTABLE BIKE RACK FOR BICYCLE INCLUDING WIDE TIRES

(71) Applicant: Bell Sports, Inc., Scotts Valley, AZ (US)

(72) Inventors: Tony M. Ton, Santa Cruz, CA (US); Robin Sansom, Santa Cruz, CA (US); Vincent Wong, Kowloon (HK)

(21) Appl. No.: 15/178,379

(22) Filed: Jun. 9, 2016

Related U.S. Application Data
(60) Provisional application No. 62/174,240, filed on Jun. 11, 2015.

(51) Int. Cl. B62J 7/04

(52) U.S. Cl. CPC B62J 7/04

(57) ABSTRACT

An adjustable bike rack for bicycles including wide tires including a platform comprising at least one first sleeve and at least one second sleeve. A first side piece comprises at least one first prong. A second side piece comprises at least one second prong. A narrow position is defined by the at least one first prong being fully inserted within the at least one first sleeve and the at least one second prong being fully inserted within the at least one second sleeve. A wide position is defined by the at least one first prong being minimally inserted within the at least one first sleeve and the at least one second prong being minimally inserted within the at least one second sleeve. A plurality of tightening devices are adapted to releasably fix a position of the adjustable bike rack into the narrow position or the wide position.

### RELATED APPLICATION

This application claims the benefit of U.S. provisional patent application 62/174,240, filed Jun. 11, 2015 titled “Adjustable Bike Rack for Bicycle Including Wide Tires,” the entirety of the disclosure of which is incorporated by this reference.

### TECHNICAL FIELD

This disclosure relates to an adjustable bike rack for bicycle including wide tires and a method of using the same.

### BACKGROUND

Bicycle racks can be permanently or temporarily attached to bicycles 10 to increase the capacity of the bicycle 10 for passively carrying cargo or transporting goods without the rider actively carrying, holding, or managing the goods. US Pat. Pub. 2009/0159626 to Hoidal et al. (hereinafter “Hoidal”) is an example of such a bike rack or carrier 1. FIG. 1 is an example of the bike rack 1 mounted to a bicycle 10, as disclosed in FIG. 1 of Hoidal.

FIG. 1 shows that the carrier 1 can comprise a carrier top 2, one or more supporting members 3 that extend from the carrier top to mounting points 4, and a front connector 5 that is attached to the carrier by a rod 9. The supporting members 3 can be formed of from aluminum for both lightness and strength. The carrier 1 can be fixed to bicycles comprising a variety of different heights, such as bicycles comprising different wheel heights to accommodate riders of differing heights by adjusting a length of the supporting members 3 attached to the carrier top 2, by coupling the supporting members 3 or rods to a height adjusting block that can adjust a height of the carrier 1 to accommodate various heights.

### SUMMARY

A need exists for an adjustable bike rack for bicycles including wide tires. Accordingly, in an aspect, an adjustable bike rack for bicycles including wide tires can include a platform comprising at least one first sleeve and at least one second sleeve. A first side piece can include at least one first prong. A first attachment device can include an adjustable height and can be extendably coupled to the first side piece to provide a variable height for the adjustable bike rack. A second side piece can include at least one second prong. A second attachment device can include an adjustable height and extendably coupled to the second side piece to provide a variable height for the adjustable bike rack. A narrow position can be defined by the at least one first prong being fully inserted within the at least one first sleeve and the at least one second prong being fully inserted within the at least one second sleeve. A wide position can be defined by the at least one first prong being minimally inserted within the at least one first sleeve and the at least one second prong being minimally inserted within the at least one second sleeve. A plurality of tightening devices can be adapted to releasably fix a position of the adjustable bike rack into the narrow position or the wide position.

The adjustable bike rack for bicycles including wide tires can further comprise the tightening devices comprising a first threaded fastener that extends through the at least one first sleeve to the at least one first prong and creates friction between an inner surface of the at least one first sleeve and an outer surface of the at least one first prong to prevent relative movement of the at least one first sleeve and the at least one first prong, and a second threaded fastener that extends through the at least one second sleeve to the at least one second prong and creates friction between an inner surface of the at least one second sleeve and an outer surface of the at least one second prong to prevent relative movement of the at least one second sleeve and the at least one second prong. The at least one first sleeve can comprises an inner surface, the at least one first prong can comprise an outer surfaces mateably sized with the inner surface of the at least one first sleeve, and the at least one second sleeve comprises an inner surface, the at least one second prong comprises an outer surface mateably sized with the inner surface of the at least one second sleeve. The at least one first sleeve and the at least one second sleeve can comprise hollow tubes. The platform can comprise a solid surface, an open surface, or a basket. The narrow position can comprise a narrow wheel width Ww1 in a range of 10.9-14.6 cm, and the wide position can comprise a wide wheel width Ww2 in a range of 15.5-20.9 cm.

In another aspect, an adjustable bike rack for bicycles including wide tires can include a platform comprising a first sleeve and a second sleeve, a first side piece comprising first prong, a second side piece comprising second prong, and a narrow position defined by the first prong being fully inserted within the first sleeve and the second prong being fully inserted within the second sleeve. A wide position can be defined by the first prong being minimally inserted within the first sleeve and the second prong being minimally inserted within the second sleeve, and a plurality of tightening devices can be adapted to releasably fix a position of the adjustable bike rack into the narrow position or the wide position.

The adjustable bike rack for bicycles including wide tires can further include a first attachment device comprising an adjustable height and extendably coupled to the first side piece to provide a variable height for the adjustable bike rack, and a second attachment device comprising an adjustable height and extendably coupled to the second side piece to provide a variable height for the adjustable bike rack. The plurality of tightening devices can comprise a first threaded fastener that extends through the first sleeve to the first prong and creates friction between an inner surface of the first sleeve and an outer surface of the first prong to prevent relative movement of the first sleeve and the first prong, and a second threaded fastener that extends through the second sleeve to the second prong and creates friction between an inner surface of the second sleeve and an outer surface of the second prong to prevent relative movement of the second sleeve and the second prong. The first sleeve comprises an inner surface, the first prong comprises an outer surfaces mateably sized with the inner surface of the first sleeve, the second sleeve comprises an inner surface, and the second prong comprises an outer surface mateably sized with the inner surface of the second sleeve. The first sleeve and the second sleeve can comprise hollow tubes. The platform can comprise a solid surface, an open surface, or a basket. The narrow position can comprise a narrow wheel width Ww1 in a range of 10.9-14.6 cm, and the wide position can comprise a wide wheel width Ww2 in a range of 15.5-20.9 cm.

In another aspect, an adjustable bike rack for bicycles including wide tires can include a platform comprising a first sleeve and a second sleeve, a first side piece coupled to the platform with a first sleeve and a first prong, a second side piece coupled to the platform with a second sleeve and a second prong, a narrow position defined by the first prong being fully inserted within the first sleeve and the second prong being fully inserted within the second sleeve, and a wide position defined by the first prong being minimally inserted within the first sleeve and the second prong being minimally inserted within the second sleeve.

The adjustable bike rack for bicycles including wide tires can further include a plurality of tightening devices adapted to releasably fix a position of the adjustable bike rack into the narrow position or the wide position. A first threaded fastener can extends through the first sleeve to the first prong and creates friction between an inner surface of the first sleeve and an outer surface of the first prong to prevent relative movement of the first sleeve and the first prong, and a second threaded fastener can extend through the second sleeve to the second prong and creates friction between an inner surface of the second sleeve and an outer surface of the second prong to prevent relative movement of the second sleeve and the second prong. The first sleeve can comprise an inner surface, the first prong comprises an outer surfaces mateably sized with the inner surface of the first sleeve, the second sleeve comprises an inner surface, and the second prong can comprise an outer surface mateably sized with the inner surface of the second sleeve. The first sleeve and the second sleeve can comprise hollow tubes. Lengths Pl of the first prong and the second prong are in a range of 3.8-7.9 cm. The narrow position can comprise a narrow wheel width Ww1 in a range of 10.9-14.6 cm, and the wide position can comprise a wide wheel width Ww2 in a range of 15.5-20.9 cm.

### BRIEF DESCRIPTION OF THE DRAWINGS

FIG. 1 shows a view of a bike rack as known in the prior art.

FIGS. 2A-2F show various views of an adjustable bike rack for bicycles including wide tires.

FIGS. 3A and 3B show various views of an adjustable bike rack for bicycles including wide tires comprising a basket.

FIGS. 4A and 4B show various views of an adjustable bike rack for bicycles including wide tires.

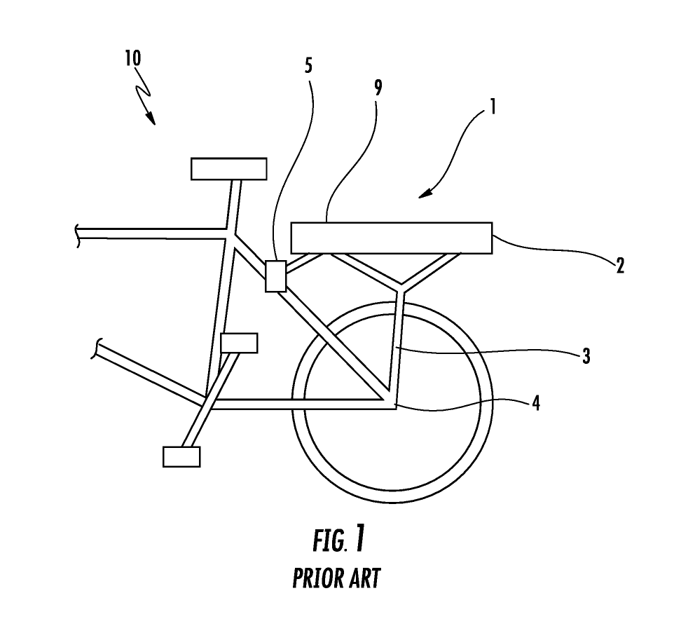

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The words “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes embodiments of many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

This disclosure provides a system and method for providing a bicycle rack comprising a variable or adjustable width that allows the bicycle rack to accommodate different bicycles of differing widths, including for example, those bicycles comprising tires of differing widths. By accommodating bicycles of different widths, the bicycle rack disclosed herein differs from conventional bicycle racks known in the art, which are configured and designed to be used with a single or standard width bicycle.

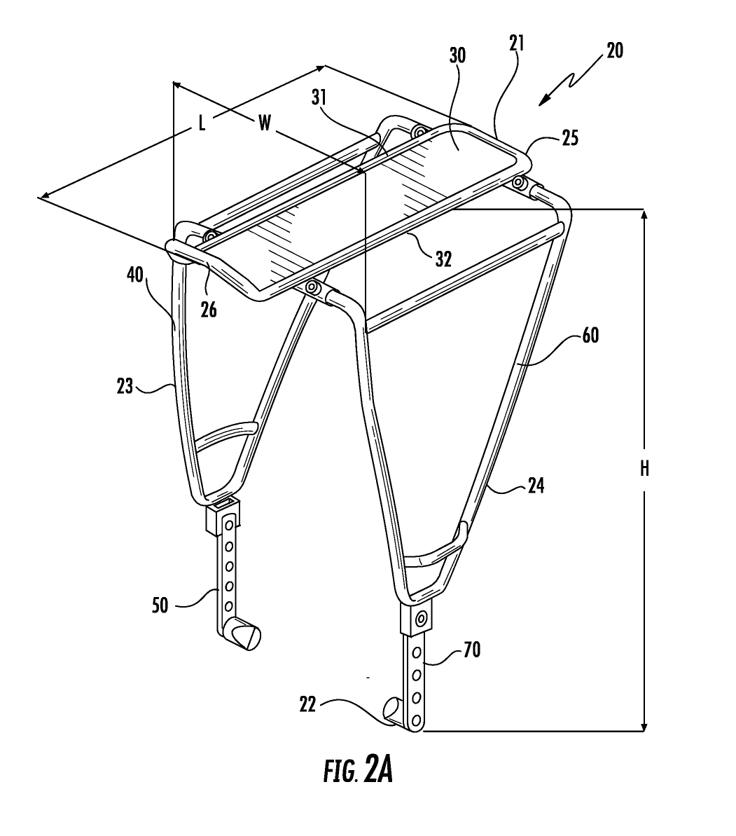

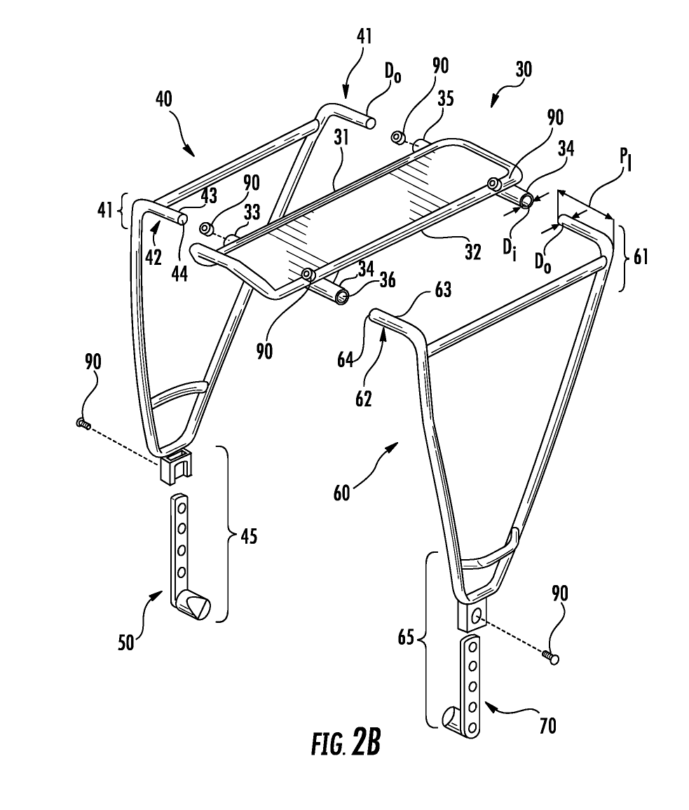

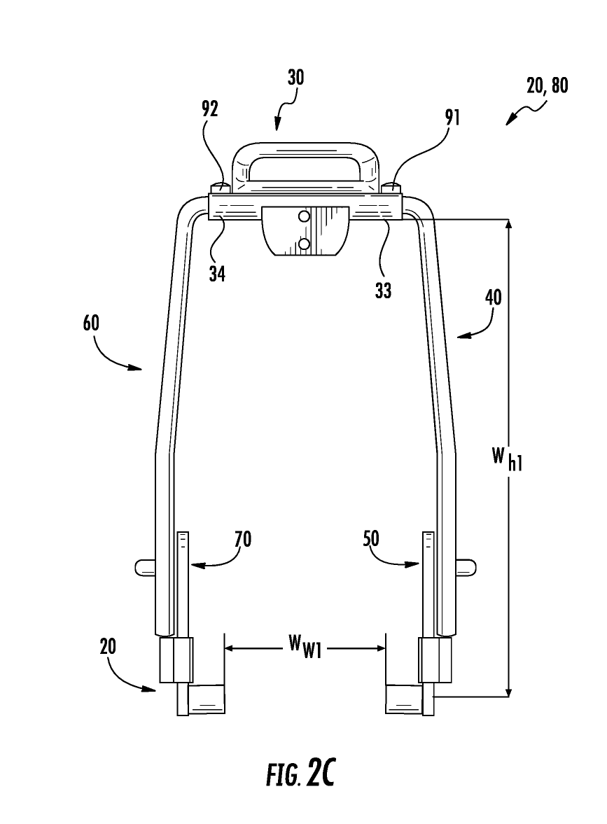

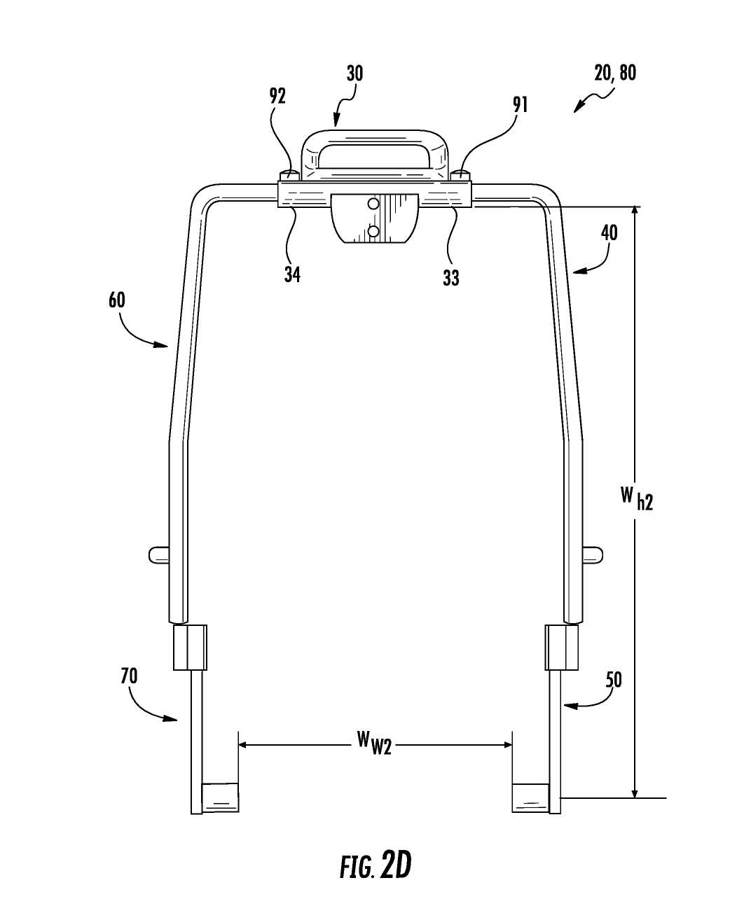

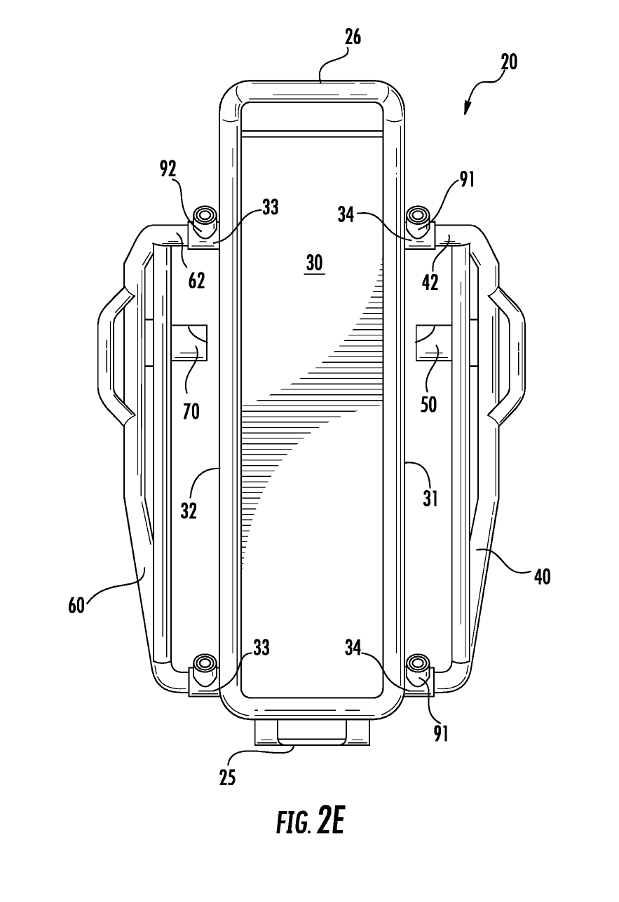

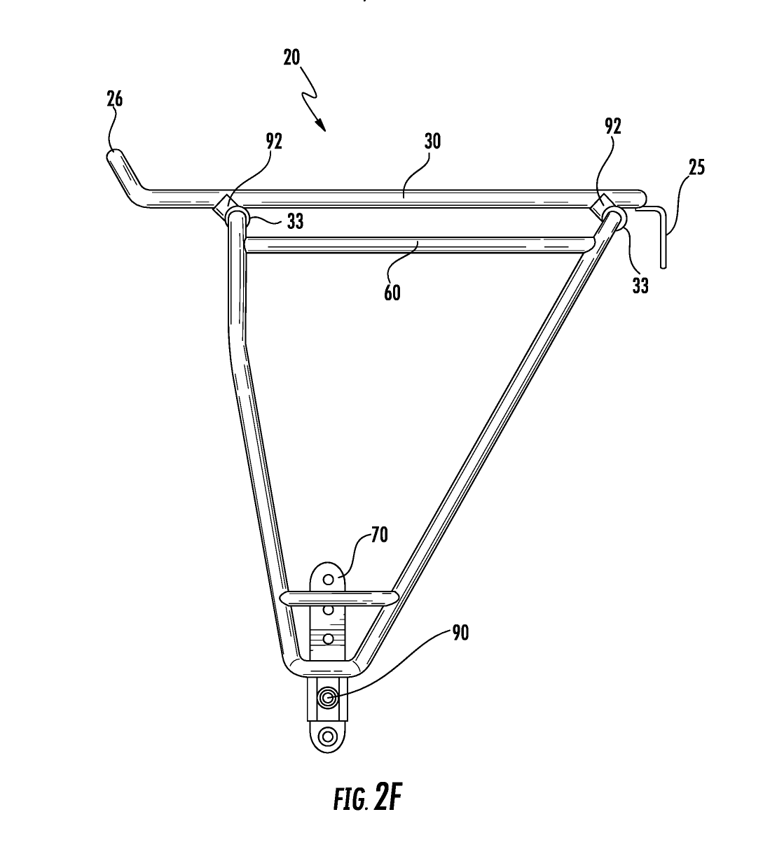

FIGS. 2A-2F show various views of an adjustable bike rack 20 for bicycles including wide tires. More particularly, FIG. 2A is a perspective view of the adjustable width bicycle rack 20 that comprises a top piece, portion, platform, horizontal member, or basket 30. The top piece 30 comprises a first or left side 31 and second or right side 32. The adjustable width bicycle rack 20 further comprises two opposing side pieces: a first or left side piece, frame, or vertical support 40, and a second or right side piece, frame, or vertical support 60. The two opposing side pieces 40 and 60 can move and expand or contract relative to each other and relative to the top piece 30 to produce a rack 20 of differing widths. The first side piece 40 can also be coupled to a first attachment device 50 that comprises an adjustable height and can be extendably coupled to the first side piece 40 to provide a variable height for the adjustable bike rack 20. Similarly, the second side piece 60 can also be coupled to a second attachment device 70 that comprises an adjustable height and can be extendably coupled to the second side piece 60 to provide a variable height for the adjustable bike rack 20.

The rack 20, including top piece 30, side pieces 40 and 60, as well as the attachment devices 50 and 70 can be made of tubing, portions, or pieces, of metal, plastic, wood, fiber, such as fiberglass, carbon fiber, or composite material. The tubing can be hollow, solid, multi-layered, or filled, and can comprise a cross-sectional shape of any geometric or organic form, including a circle, oval, square, rectangle, diamond, or any other polygon or other suitable shape that can be constant or vary along a length of the tubing. The tubing can be formed of one or more pieces, portions, or segments, that are integrally formed, or individually formed and subsequently joined, such as by an adhesive, mechanical fasteners, welding soldering, or other known way of attachment. As a non-limiting example, the tubing can be formed of welded aluminum tubing, and comprise both fixed and adjustable portions that can be rigidly and releasably coupled, respectively. Releasably coupled portions can include threaded locking mechanism that can be tightened to preserve a relative position of a portion of the adjustable width bicycle rack.

The terms “top,” “bottom,” “front,” “back,” “right side,” and “left side,” or “directions” as used herein are relative non-limiting terms that are used for convenience of description. The directions of the adjustable width bicycle rack 20 can correspond to directions of a bicycle to which the adjustable width bicycle rack 20 is coupled, or to a rider of the bicycle. The bicycle can be a conventional bicycle, such as bicycle 10, and can also be a bicycle comprising wide, thick, or fat tires, dimensions of which are discussed in greater detail below. Additionally, a top or top end 21 of the rack 20 and a bottom or bottom end 22 of the rack 20 can be disposed at opposing ends of a height H of the rack 20. Similarly, a width W of the rack 20 can be in a direction that is perpendicular or orthogonal to the height H of the rack 20 and can correspond to a direction that extends between a first or left side 23 and a second or right side 24 of the rack 20. Additionally, a length L of the rack 20 can be in a direction that is perpendicular or orthogonal to both the height H and the width W of the rack 20, and can correspond to a direction that extends between a front 25 and a rear 26 of the rack 20. Accordingly, the length L of the rack 20 can be in a direction of, or coextensive with a part of, a length of the bicycle to which it is mounted, such as the direction between front and rear wheels of the bicycle. However, the orientation of the adjustable width bicycle rack 20, including the height H, the width W, and the length L, as described herein, are for convenience, are non-limiting, and can be reversed, changed, or modified without departing from the scope of the disclosure.

FIG. 2B shows an exploded perspective view of the rack 20, similar to the view of the rack 20 shown in FIG. 2A. FIG. 2B further shows a top portion 41 of the left side piece 40, and a top portion 61 of the right side piece 60, which shown aligned with, and prepared to coupled to, the top piece 30 of the adjustable width bicycle rack 20. The top portions 41 and 61 can comprise the upper 0-30%, 0-20%, or 0-10% of the height H of the rack 20. In some instances, the top piece 30 can include a upper portion that forms a lip, railing, or rim along one or more sides of the top piece, which can be used in helping maintain cargo loaded onto the top piece of the adjustable width bike rack. As shown in FIGS. 2A and 2B, the top portions 41, 61 of the side pieces 40, 60, respectively, can comprise tangs, tines, prongs, or other similar elements 42, 62, that can be adjustably coupled to the top piece 30 of the adjustable width bicycle rack 20 to permit and facilitate relative movement between the top piece 30 and the side pieces 40, 60 of the adjustable width bicycle rack 20. The top piece 30 can preserve or maintain a gap or offset between the two opposing side pieces 40, 60, into which a bicycle wheel, such as a front or rear wheel of the bicycle can be disposed. Thus, one or more of the adjustable width bicycle racks 20 can be positioned over a front wheel, a rear wheel, or both front and rear wheels, of a variety of bicycles comprising different widths of wheels to allow for carrying, holding, and transporting of objects.

As shown in FIG. 2B the first side piece 40 comprises a first prong, tang, rod, tube, tine, or connector 42, and the second side piece 60 comprises a second prong, tang, rod, tube, tine, or connector 62. The first prongs 42 correspond to, and are releasably coupled to, a first, left, or front sleeve, collar, or receiver 33 coupled to the first side 23 of top piece 30 or rack 20. Similarly, the second prongs 62 correspond to, and are releasably coupled to, a second, right, or rear sleeve, collar, or receiver 34 coupled to on second side 24 of top piece 30 or rack 20. A narrow position 80 of the rack 20, shown in FIG. 2C, can be defined by the at least one first prong 42 being fully inserted within the at least one first sleeve 33 and the at least one second prong 62 being fully inserted within the at least one second sleeve 34. On the other hand, a wide position 82 of the rack 20, shown in FIG. 2D, can be defined by the at least one first prong 42 being partially or minimally inserted within the at least one first sleeve 33 and the second prong being partially or minimally inserted within the at least one second sleeve 34.

A plurality of tightening devices, threaded fasteners, screws, thumb screws, wing nuts, or other similar devices 90 can be adapted to releasably fix a position of the adjustable bike rack 20 into the narrow position 80 or the wide position 82. A first threaded fastener 91 can extend through the first sleeve 33 to the first prong 34 and create friction between an inner surface 35 of the first sleeve 33 and an outer surface 43 of the first prong 42 to prevent relative movement of the first sleeve 33 and the first prong 42. Similarly, a second threaded fastener 92 can extend through the second sleeve 34 to the second prong 62 and create friction between an inner surface 36 of the second sleeve 34 and an outer surface 63 of the second prong 62 to prevent relative movement of the second sleeve 34 and the second prong 62. As such, the first sleeve 33 can be formed as a hollow tube with the inner surface 35 mateably sized with the outer surface 43 of the first prong 42, the first sleeve 33 having an inner distance, diameter, or thickness Di and the outer surface 43 of the first prong 42 having an outer distance, diameter, or thickness Do. The second sleeve 34 can likewise be formed as hollow tube with the inner surface 36 mateably sized with the outer surface 63 of the second prong 62, the second sleeve 34 having an inner distance or diameter Di and the outer surface 63 of the second prong 62 having an outer distance or diameter Do. In some instances the inner diameter Di will be in a range of 0.6-2.5 cm, or 1.1-1.4 cm, and the outer diameter Do will be in a range of 0.6-2.5 cm, or 1.1-1.4 cm, wherein a difference between mateably coupled Di and Do is in a range of 0-2, or 0-3 millimeters (mm).

A thickness Do of the prongs 42, 62 can be the same or similar as the thickness of the material, such as tubing, that is used for other parts of the adjustable width bicycle rack 20. The prongs 42, 62 of the first side piece 40 and the second side piece 60 can be aligned, or collinear, with each other, as shown throughout the FIGs. In other embodiments, the prongs 42, 62 of the first side piece 40 and the second side piece 60 can be offset, pass by, or overlap one with another to create the minimum rack width 80 without ends 44, 64 of the prongs 42, 62 touching or being in direct contact. When the prongs 42, 62 are co-linear, the prongs 42, 62 can comprise a prong length Pl, directed across the width W of the adjustable width bicycle rack 20, of about 3.8-7.9 centimeters (cm), 5.1-7.6 cm, or 6.4 cm, wherein “about” as used herein can mean plus or minus 0-2 cm. Thus, a total adjustability of the bicycle rack 20 can be twice the prong length Pl, or twice a distance of the prong length Pl minus a length of the prongs remaining within first and second sleeves 33, 34 to maintain the prong firmly coupled to the first and second sleeves 33, 34 and the top piece 30 of the adjustable width bicycle rack 30. As such, a total adjustability of the width W of the bicycle rack 20 can be about 7.6-15.8 cm, or 10.2-15.2 cm, or 12.8 cm, where “about” can mean plus or minus 0-4 cm. In some instances, the adjustable width W of the bike rack 20 can be in a range of about 14.68-20.68 cm. A range of about 14.68-20.68 can allow the rack 20 to be used on plus sized tire bikes, which can typically comprise bike rear racks comprising widths of about 14.6 cm. Similarly, the adjustable width bike rack 20 can accommodate plus sized tire bikes, including front hubs, rear hubs, or both front and rear hubs. Common ranges for front and rear hubs of bicycles that can be accommodated by the adjustable width bike rack 20 can, without limitation, include widths of about 13.5 cm for front hubs or tires and widths of 13.5-19.5 cm for rear hubs or tires.

Furthermore, widths typically needed for standard bike front racks is about 11.0 cm, which falls within a range of widths that can be accommodated by the present adjustable width bike rack 20, which can, as a non-limiting example, adjust from 10.9 cm wide to 15.55 cm wide, allowing the same adjustable width bike rack 20 to fit, and be used with, front, rear, or both front and rear tires or hubs of both conventional or wide tire bicycles, which has not previously been available from a standardized off-the-shelf adjustable width bike rack. Accordingly, the wide ranges of width adjustment and the degree or magnitude of adjustability provided by the adjustable width bike rack 20 allows the adjustable width bike racks 20 to fit both front and rear portions of a bike frame, as well as both front and rear bike wheel axels and mounting points, which has not been achieved by conventional or standard fixed racks. To the contrary, standard fixed racks have not been intended for, or been designed to accommodate both front and rear configurations, let alone front and rear configurations of standard width bicycles and bicycles including wide tires.

Lower or bottom portions 45, 65 of the side pieces 40, 60, respectively, or the rack 20, can be formed opposite the top portions 41, 61 of the adjustable width bicycle rack 20 or the side pieces 40, 60. The bottom portions 45, 65 can comprise, or be coupled to, the first attachment device 50 and the second attachment device 70, which facilitate coupling of the rack 20 to the bicycle, such as at or near a front or rear axel of the bicycle. The attachment devices 50, 70, can also provide for adjustment of the height H of the adjustable width bicycle rack 20 to accommodate bicycles of different sizes and heights. In some instances, the attachment devices 50, 70 can be slidably situated within a sleeve formed on, or coupled to, the side pieces 40, 60, and held in a desired position with tightening devices 90.

FIG. 2C shows a front profile view of the adjustable width bicycle rack 20 in which the adjustable width bicycle rack 20 is shown in its narrow, small, or minimum position or width 80, wherein the width W of the rack is measured in a direction between the left and right sides of the rack 20, and with the prongs 42, 62 of the side pieces 40, 60 fully inserted within the sleeves 33, 34 of the top piece 30, and top portions 41, 61 of the side pieces 40, 60 adjacent or abutting the side portions 31, 32 of the top piece 30. FIG. 2C further shows the adjustable width bicycle rack 20 with the prongs 42, 62 of the side pieces 40, 60 extending through the sleeves 33, 34, which can be disposed or formed on an underside or bottom surface of the top piece 30. In other instances, relative positions of the prongs 42, 62 and sleeves 33, 34 can be reversed such that the prongs 42, 62 are directly coupled to the top portion 30 and the sleeves 33, 34 are coupled to the side pieces 40, 60. When the prongs 42, 62 are coupled to the top piece 30, protruding ends of the prongs 42, 62 in the narrow position 80 can be covered or surrounded by deflection material to prevent the prongs 42, 62 from undesirably snagging or contacting objects. In either event, the sleeves 33, 34 and the prongs 42, 62 can allow or provide for an increased range of interaction or spacing between the side pieces 40, 60 of the adjustable width bicycle rack 20.

FIG. 2C shows the adjustable width bicycle rack 20 in the narrow position 80 so that the prongs 42, 62 of the side pieces 40, 60 are fully or completely inserted through the sleeves 33, 34. Distal ends 44, 64 of the prongs 42, 62 can be adjacent one another, and can be touching, or can be nearly touching, so that the distal ends 44, 64 of the prongs 42, 62 are separated by distances in a range of 0-3.0 cm, 0-2.0 cm, or 0-1.0 cm. When the adjustable width bike rack 20 is at its narrowest width, a separation or distance between top portions 41, 61 of the opposing side pieces 40, 60 excluding the prongs 42, 62 can be a distance in a range of about 7.6-17.8 cm, or 10.1-15.3 cm, or about 12.7 cm. A first or narrow wheel width Ww1, or the width facilitated by the rack 20 for a wheel at the narrow position 80 can be a minimum of 10.9-14.6 cm, while a first or short wheel height Wh1, or the height facilitated by the rack 20 for a wheel at the short position when attachment devices 50, 70 are retracted, can be a minimum of 31.6-39.0 cm.

FIG. 2D shows the adjustable width bicycle rack 20 at the wide position 82 with its greatest or largest width with the prongs 42, 62 of the side pieces 40, 60 inserted within the sleeves 33, 34, but not extending through the sleeves 33, 34 at an interior area of the top piece 30 of the adjustable width bicycle rack 20. While the term “greatest or largest width” has been used herein for convenience, it is understood that an absolute or larger width could be achieved by allowing for only partial or minimal overlap of the prongs and the sleeves, or by increasing the length of the prongs Pl. However, in some instances total or substantial overlap between the tubes and the prongs is desirable to increase strength and prevent slippage.

FIG. 2D shows the adjustable width bicycle rack at its largest width so that the distal ends 44, 64 of the prongs 42, 62 of the opposing side pieces are offset one from another, and can be separated by distances in a range of about 5.1-10.2 cm, 6.4-8.9 cm, or 7.6 cm. At its largest width, distal ends 42, 62 of the prongs 42, 62 of the adjustable width bike rack 20 can be separated by a distance equal to a distance of the separation between the sleeves 33, 34 of the top piece 30, which can be in a range of about 5.1-10.2 cm, 6.4-8.9 cm, or 7.6 cm. A second or wide wheel width Ww2, or the width facilitated by the rack 20 for a wheel at the wide position 82 can be a maximum of 15.5-20.9 cm, while a first or short wheel height Wh2, or the height facilitated by the rack 20 for a wheel at the short position when attachment devices 50, 70, when retracted, can be a maximum of 39.0-44.3 cm.

While FIGS. 2C and 2D show the adjustable width bicycle rack 20 in the narrow position 80 and the wide position 82, respectively, any number of intermediate positions can also be achieved by moving or adjustably sliding the prongs 42, 62 of the side pieces 40, 60 to an intermediate position between the narrow position 80 and wide position 82. Accordingly, any number of positions can be obtained between the narrow position 80 and the wide position 82 according to variability of bicycle widths and a particular desired width for the adjustable width bicycle rack 20.

FIG. 2E, shows a top view of the adjustable width bicycle rack 20 in the wide position 82. A number of tightening devices 90 are shown as first and second tightening devices 91, 92 or circular threaded fasteners extending through openings in the sleeves 33, 34 at the top 30 of the adjustable width bicycle rack 20. The tightening devices 90 can comprise a threaded shaft, screw, spring loaded device, a latch, lever, clamp, or any other suitable device that can be releasably or permanently coupled to the prongs 42, 62 of the side pieces 40, 60 to secure the adjustable width bicycle rack 20 to maintain a desired width W of the adjustable width bicycle rack 20, such as a width that is appropriate for a desired bicycle. While the tightening devices 90 are shown including a circular shape, the tightening devices 90 can comprise any shape, including any geometric or organic form, such as a circle, oval, square, rectangle, diamond, or any other polygon or other suitable shape.

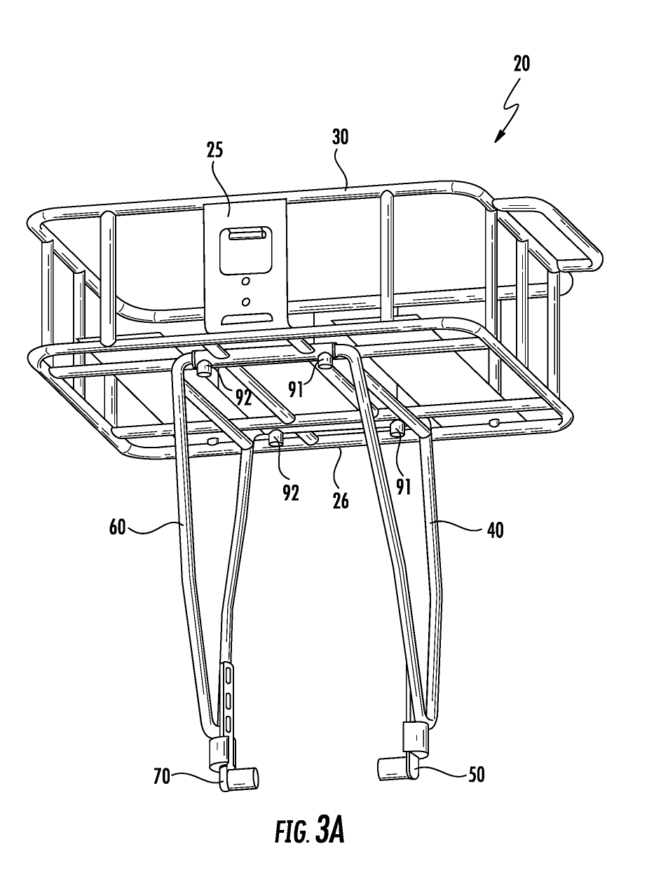

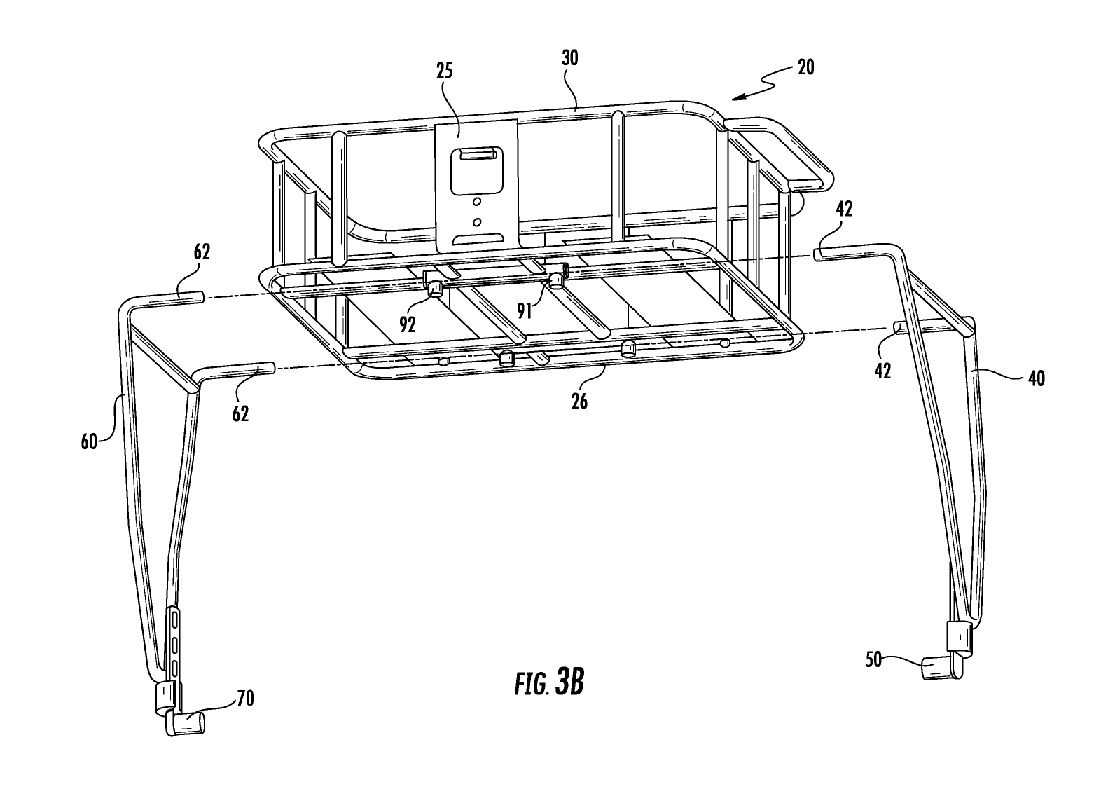

While the top piece 30 is shown in FIG. 2E comprising an open rack of tubing with a solid plate, the top piece 30 can further comprise an open surface without a solid plate or closed surface. The top piece 30 can be planar, such as a platform; or alternatively, the top piece 30 can be shaped to enclose a length, width, and depth. In yet other instances, the top piece 30 can be formed as, or include, a basket, crate, child seat, or any other specialized type of holding piece or equipment that can be configured, arranged, or adapted to holding or transport of a particular object, type of object, or class of objects. The top piece 30 can also be interchangeable so that more than one of the above mentioned top pieces 30, such as a platform, basket, or child seat, can be removably or temporarily coupled to the side pieces 40, 60 as discussed in greater detail with respect to FIGS. 3A and 3B.

FIG. 2F shows a side view of a non-limiting example of the rack 20, including the attachment device 70 coupled to a bottom portion 22 of the rack 20 and the side piece 60. As shown in FIG. 2F, and throughout the FIGs., the attachment devices 50, 70 can comprise an element for attaching to the bicycle, such as to an axle or near an axel of the bicycle. The attachment devices 50, 70 can further comprise a number of vertically separated holes or openings that can facilitate adjustment of a height H of the adjustable width bicycle rack 20, depending on which vertically separated holes are used by the tightening devices 90. The attachment device shown in FIG. 2F in its most recessed or highest position for the smallest overall height, which is in contrast with FIG. 2D, where the attachment device is in its lowest position for the largest overall height.

Advantageously, the adjustable width bicycle rack 20 disclosed herein provides for increased adaptability with respect to bicycle racks previously known in the art. The adjustable width bicycle rack 20 allows for customization of a width W of the adjustable width bicycle rack 20 to accommodate bicycles of a variety of widths, including tires of a variety of widths. While the adjustable width rack 20 is referred to herein as an adjustable width “bicycle” rack, in some instances, the ranges of widths accommodated by the adjustable width bicycle rack 20 will allow the adjustable width bicycle rack to be used not only for bicycles, but also for mopeds, motorcycles, scooters, motor scooters, dirt bikes, street bikes, road motorcycles, tricycles, all terrain vehicles, or any other suitable vehicle, including 2-wheeled and 3-wheeled vehicles.

FIGS. 3A and 3B, as alluded to above, show the top piece 30 of the adjustable width bicycle rack 20 can be interchanged or reconfigured to accommodate different structures and uses of the top piece 30, such as the basket or box-like structure, to at least partially enclose a volume and better facilitate certain types of storage and transport. The perspective views of FIGS. 3A and 3B show an embodiment of the adjustable width bicycle rack 20 from an angle below the top portion 30. In some instances, the top piece 30 can include a upper portion that forms a lip, railing, or rim along one or more sides of the top piece, which can be used in helping maintain cargo loaded onto the top piece of the adjustable width bike rack. The basket can comprise a base section or bottom portion that contains, or is coupled or directly attached to sleeves 33, 34 for receiving the prongs 42, 62 of the side pieces 40, 60 to facilitate a range of tire widths for different bicycles, and for the differences between front tires and back tires of a single bicycle. The ranges of widths provided by the top pieces 30 of the adjustable width bicycle rack 20 can be the same or similar to those discussed above, independent of whether the top piece 30 of the adjustable width bicycle rack is formed as a flat platform, as a box, basket, or crate, or any other suitable structure. In FIG. 3A, the side pieces 40, 60 of the adjustable width bicycle rack 20 are shown in a narrow position in which the side pieces are fully inserted into the tubes, channels, or receiving pieces of the top piece.

FIG. 3B shows another perspective view of the embodiment of the adjustable width bicycle rack, similar to the perspective view shown in FIG. 3A. FIG. 3B differs from FIG. 3A in that FIG. 3B shows an exploded view in which the side pieces 40, 60 and prongs 42, 62 of the adjustable width bicycle rack 20 are shown offset from, but aligned with, the sleeves 33, 34 of the top piece 30.

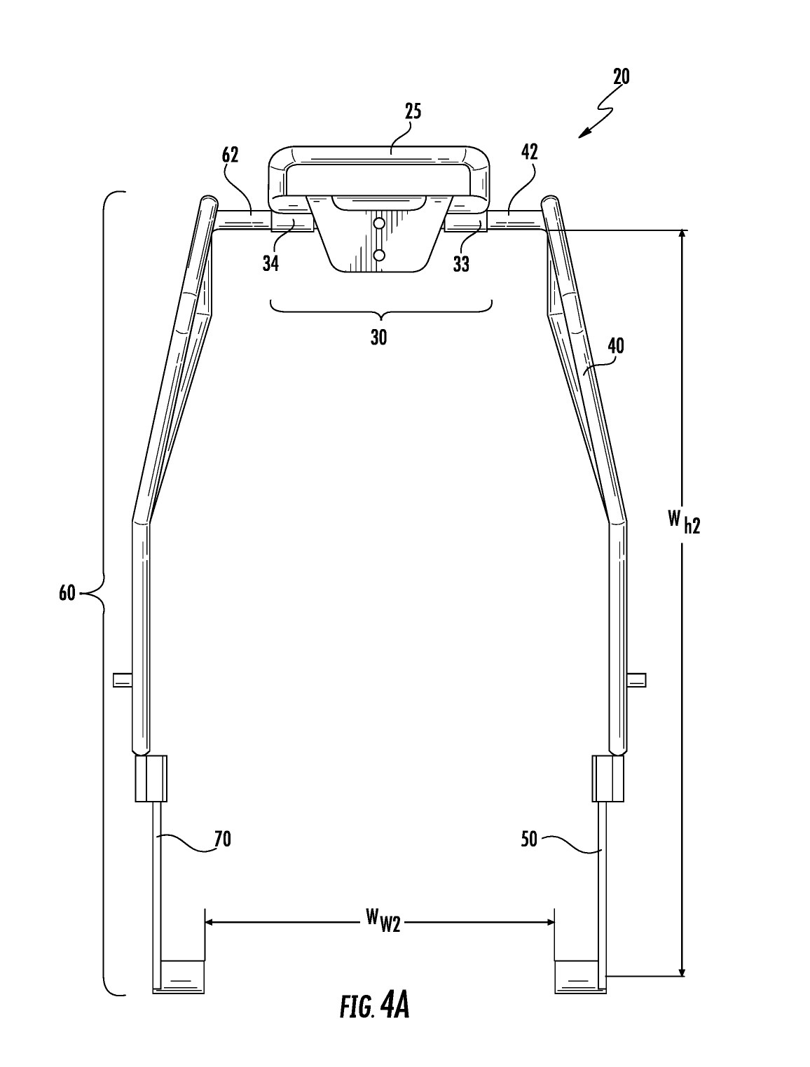

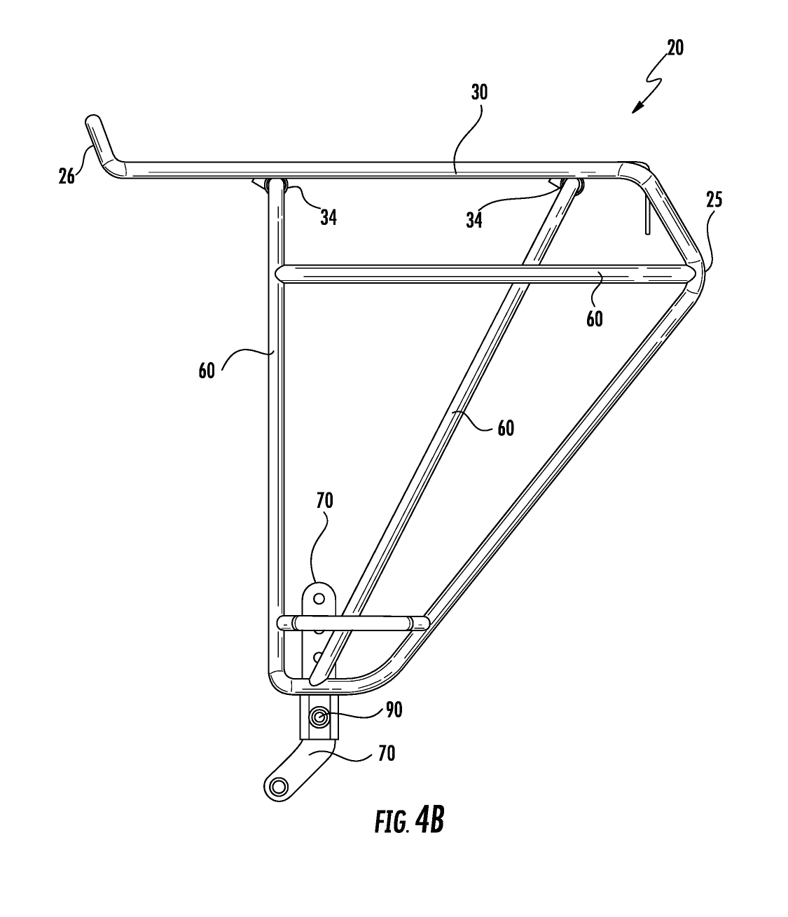

FIGS. 4A and 4B show another non-limiting example or variation of the bicycle rack 20, in which the side pieces 40, 60 can comprise a different configuration or arrangement of support members or tubing. More specifically, FIGS. 4A and 4B, similar to FIGS. 2D and 2F, respectively, show how portions of the side pieces 40, 60 can cover or substantially cover the first and second sides 31, 32 of the top piece 30 of the rack 20.

It will be understood that the embodiments disclosed are not limited to the specific components disclosed herein, as virtually any components consistent with the intended operation of a method and/or system implementation for such an embodiment may be utilized. Accordingly, for example, although particular component examples may be disclosed, such components may be comprised of any shape, size, style, type, model, version, class, grade, measurement, concentration, material, weight, quantity, and/or the like consistent with the intended purpose, method and/or system of implementation.

In places where the description above refers to particular implementations or embodiments, it should be readily apparent that a number of modifications may be made without departing from the scope and/or spirit thereof and that these principles and modifications may be applied to other such embodiments. The presently disclosed embodiments are, therefore, to be considered in all respects as illustrative and not restrictive.

Where the above examples, embodiments and implementations reference examples, it should be understood by those of ordinary skill in the art that other manufacturing devices and examples could be intermixed or substituted with those provided. In places where the description above refers to particular embodiments and customization methods, it should be readily apparent that a number of modifications may be made without departing from the spirit thereof and that these embodiments and implementations can be applied to other customization technologies as well. Accordingly, the disclosed subject matter is intended to embrace all such alterations, modifications and variations that fall within the spirit and scope of the disclosure and the knowledge of one of ordinary skill in the art.

What is claimed is:

1. An adjustable bike rack for bicycles including wide tires, comprising:
a platform comprising at least one first sleeve and at least one second sleeve;
a first side piece comprising at least one first prong;
a first attachment device comprising an adjustable height and extendably coupled to the first side piece to provide a variable height for the adjustable bike rack;
a second side piece comprising at least one second prong;
a second attachment device comprising an adjustable height and extendably coupled to the second side piece to provide a variable height for the adjustable bike rack;
a narrow position defined by the at least one first prong being fully inserted within the at least one first sleeve and the at least one second prong being fully inserted within the at least one second sleeve;
a wide position defined by the at least one first prong being minimally inserted within the at least one first sleeve and the at least one second prong being minimally inserted within the at least one second sleeve; and
a plurality of tightening devices adapted to releasably fix a position of the adjustable bike rack into the narrow position or the wide position.

2. The adjustable bike rack of claim 1, wherein the plurality of tightening devices comprises:
a first threaded fastener that extends through the at least one first sleeve to the at least one first prong and creates friction between an inner surface of the at least one first sleeve and an outer surface of the at least one first prong to prevent relative movement of the at least one first sleeve and the at least one first prong; and
a second threaded fastener that extends through the at least one second sleeve to the at least one second prong and creates friction between an inner surface of the at least one second sleeve and an outer surface of the at least one second prong to prevent relative movement of the at least one second sleeve and the at least one second prong.

3. The adjustable bike rack of claim 1, wherein:
the at least one first sleeve comprises an inner surface;
the at least one first prong comprises an outer surfaces mateably sized with the inner surface of the at least one first sleeve;
the at least one second sleeve comprises an inner surface; and
the at least one second prong comprises an outer surface mateably sized with the inner surface of the at least one second sleeve.

4. The adjustable bike rack of claim 3, wherein the at least one first sleeve and the at least one second sleeve comprise hollow tubes.

5. The adjustable bike rack of claim 1, wherein the platform comprises solid surface, an open surface, or a basket.

6. The adjustable bike rack of claim 1, wherein:
the narrow position comprises a narrow wheel width Ww1 in a range of 10.9-14.6 cm; and
the wide position comprises a wide wheel width Ww2 in a range of 15.5-20.9 cm.

7. An adjustable bike rack for bicycles including wide tires, comprising:
a platform comprising a first sleeve and a second sleeve;
a first side piece comprising first prong;
a second side piece comprising second prong;
a narrow position defined by the first prong being fully inserted within the first sleeve and the second prong being fully inserted within the second sleeve;
a wide position defined by the first prong being minimally inserted within the first sleeve and the second prong being minimally inserted within the second sleeve; and
a plurality of tightening devices adapted to releasably fix a position of the adjustable bike rack into the narrow position or the wide position.

8. The adjustable bike rack of claim 7, further comprising:
a first attachment device comprising an adjustable height and extendably coupled to the first side piece to provide a variable height for the adjustable bike rack; and
a second attachment device comprising an adjustable height and extendably coupled to the second side piece to provide a variable height for the adjustable bike rack.

9. The adjustable bike rack of claim 7, wherein the plurality of tightening devices comprises:
a first threaded fastener that extends through the first sleeve to the first prong and creates friction between an inner surface of the first sleeve and an outer surface of the first prong to prevent relative movement of the first sleeve and the first prong; and
a second threaded fastener that extends through the second sleeve to the second prong and creates friction between an inner surface of the second sleeve and an outer surface of the second prong to prevent relative movement of the second sleeve and the second prong.

10. The adjustable bike rack of claim 7, wherein:
the first sleeve comprises an inner surface;
the first prong comprises an outer surfaces mateably sized with the inner surface of the first sleeve;
the second sleeve comprises an inner surface; and
the second prong comprises an outer surface mateably sized with the inner surface of the second sleeve.

11. The adjustable bike rack of claim 7, wherein the first sleeve and the second sleeve comprise hollow tubes.

12. The adjustable bike rack of claim 7, wherein the platform comprises solid surface, an open surface, or a basket.

13. The adjustable bike rack of claim 7, wherein:
the narrow position comprises a narrow wheel width Ww1 in a range of 10.9-14.6 cm; and
the wide position comprises a wide wheel width Ww2 in a range of 15.5-20.9 cm.

14. An adjustable bike rack for bicycles including wide tires, comprising:
a platform comprising a first sleeve and a second sleeve;
a first side piece coupled to the platform with a first sleeve and a first prong;
a second side piece coupled to the platform with a second sleeve and a second prong;
a narrow position defined by the first prong being fully inserted within the first sleeve and the second prong being fully inserted within the second sleeve; and
a wide position defined by the first prong being minimally inserted within the first sleeve and the second prong being minimally inserted within the second sleeve.

15. The adjustable bike rack of claim 14, further comprising a plurality of tightening devices adapted to releasably fix a position of the adjustable bike rack into the narrow position or the wide position.

16. The adjustable bike rack of claim 15, wherein the plurality of tightening devices comprises:
a first threaded fastener that extends through the first sleeve to the first prong and creates friction between an inner surface of the first sleeve and an outer surface of the first prong to prevent relative movement of the first sleeve and the first prong; and
a second threaded fastener that extends through the second sleeve to the second prong and creates friction between an inner surface of the second sleeve and an outer surface of the second prong to prevent relative movement of the second sleeve and the second prong.

17. The adjustable bike rack of claim 14, wherein:
the first sleeve comprises an inner surface;
the first prong comprises an outer surfaces mateably sized with the inner surface of the first sleeve;
the second sleeve comprises an inner surface; and
the second prong comprises an outer surface mateably sized with the inner surface of the second sleeve.

18. The adjustable bike rack of claim 14, wherein the first sleeve and the second sleeve comprise hollow tubes.

19. The adjustable bike rack of claim 14, wherein lengths Pl of the first prong and the second prong are in a range of 3.8-7.9 cm.

20. The adjustable bike rack of claim 14, wherein:
the narrow position comprises a narrow wheel width Ww1 in a range of 10.9-14.6 cm; and
the wide position comprises a wide wheel width Ww2 in a range of 15.5-20.9 cm.
